(19) United States
(12) Patent Application Publication
(10) Pub. No.: US 2015/0030305 A1
(43) Pub. Date: Jan. 29, 2015

(54) APPARATUS AND METHOD FOR PROCESSING STAGE PERFORMANCE USING DIGITAL CHARACTERS

(71) Applicant: DONGGUK UNIVERSITY INDUSTRY-ACADEMIC COOPERATION FOUNDATION, Seoul (KR)

(72) Inventor: Bong Kyo Moon, Seoul (KR)

(73) Assignee: DONGGUK UNIVERSITY INDUSTRY-ACADEMIC COOPERATION FOUNDATION, Seoul (KR)

(21) Appl. No.: 14/379,952

(22) PCT Filed: Apr. 12, 2013
(86) PCT No.: PCT/KR2013/003069

§ 371 Date: Aug. 20, 2014

(30) Foreign Application Priority Data
Apr. 12, 2012 (KR) 10-2012-0037916

(51) Int. Cl. G11B 27/031; G06F 3/01; G11B 27/11; H04N 5/222

(52) U.S. Cl. CPC G11B 27/031; H04N 5/2224; G06F 3/011; G11B 27/11
USPC 386/201; 386/230

(57) ABSTRACT

The present invention relates to an apparatus and method for processing a stage performance using digital characters. According to one embodiment of the present invention, an apparatus for processing a virtual video performance using a performance of an actor includes a motion input unit for receiving an input motion from the actor through a sensor attached to the body of the actor, a performance processor for creating a virtual space and reproducing a performance in real time according to a pre-stored scenario, a playable character (PC) played by the actor and acting based on the input motion, a non-playable character (NPC) acting independently without being controlled by the actor, an object, and a background being arranged and interacting with one another in the virtual space, and an output unit for generating a performance image from the performance reproduced by the performance processor and outputting the performance image to a display device.

### TECHNICAL FIELD

The present invention relates to a technique for processing a stage performance using digital characters, and more particularly to an apparatus and method for providing an audience with virtual images as a stage performance through digital characters based on performances of actors, and an infrastructure system using the apparatus.

### BACKGROUND ART

A three-dimensional (3D) film refers to a motion picture that tricks a viewer into perceiving 3D illusions by adding depth information to a two-dimensional (2D) flat screen. Such 3D films have recently emerged from the film industry and are broadly classified into stereo and Cinerama types depending on their production schemes. In the former type, a 3D effect is represented by merging two images using a time difference. In the latter type, a 3D effect is represented using a 3D illusion created when images close to a viewing angle are viewed.

In the case of a film using 3D computer graphics, once created, images are repeated without change in view of the nature of the medium. In contrast, a traditional stage performance such as a theatrical play or a musical may offer different feelings and impressions whenever it is performed or depending on actors, despite the same scenario. However, stage performances have limitations in terms of representation method and range due to the limited stage environment.

On the other hand, although guidelines or rules are set in role-playing video games like sports, the role-playing video games may enable garners to experience a new type of fun because they face a variety of situations within the rules. However, such role-playing video games are distinguished from films or stage performances in that they are very weak in narrative as art works.

Like 3D films playing in movie theaters which have been considered as unimaginable in the past 2D film industry, technology development may lead to the emergence of new entertainment and art fields. It is also expected that people who tend to lose their interest in fixed content will more and more demand arbitrary, impromptu content. That is, as expected from films, stage performances, video games, and the like, there exist potential demands for the development of new media that encompass video media added with the sense of 3D depth beyond 2D space, flexibility of content that changes bit by bit in the event of replacing an actor or in the course of repeating a performance, and unexpected fun that may be created by improvisation while maintaining a narrative.

A non-patent document cited below describes consumers' needs for new content and ripple effects caused by the emergence of new media in the film industry.
(Non-patent document 1) Origin of Cultural Upheaval in Film Market 2009, ‘3D Film’, Digital Future and Strategy Vol. 40 (May 2009), pp. 38-43, May 1, 2009.

### DISCLOSURE

### Technical Problem

An object of the present invention is to overcome the limitations of the genre of film that provides two-dimensional (2D) images repeatedly according to a conventional fixed story and representational limitations that improvised stage performances face due to spatial and technical constraints and to solve the shortcoming of conventional image content that does not satisfy audience's demands for interactions derived from various participations of actors.

### Technical Solution

To achieve the above object, one embodiment of the present invention provides an apparatus for processing a virtual video performance using a performance of an actor, the apparatus including a motion input unit for receiving an input motion from the actor through a sensor attached to the body of the actor, a performance processor for creating a virtual space and reproducing a performance in real time according to a pre-stored scenario, a playable character (PC) played by the actor and acting based on the input motion, a non-playable character (NPC) acting independently without being controlled by the actor, an object, and a background being arranged and interacting with one another in the virtual space, and an output unit for generating a performance image from the performance reproduced by the performance processor and outputting the performance image to a display device.

The motion input unit may include at least one of a sensor attached to a body part of the actor to sense a motion of the body part and a sensor marked on the face of the actor to sense a change in a facial expression of the actor.

The performance processor may guide the actor to perform a scene by providing a script of the scenario suitable for the scene to the actor in real time with the passage of time.

The apparatus may further include an NPC processor for determining an action of the NPC based on input information of the PC and environment information about the object or the virtual space. The NPC processor may dynamically change the action of the NPC in the virtual space according to an input motion from the actor or an interaction between the PC and the NPC.

The apparatus may further include a synchronizer for synchronizing the PC, the NPC and the object in the virtual space by providing the actor in real time with information about an interaction and relationship between the PC and the NPC or the object according to the performance of the actor.

The apparatus may further include a communication unit having at least two separate channels. A first channel of the communication unit may receive a speech from the actor and is inserted into the performance, and a second channel of the communication unit may be used for communication between the actor and another actor or person without being exposed in the performance.

To achieve the above object, a further embodiment of the present invention provides an apparatus for processing a virtual video performance using a performance of an actor, the apparatus including a motion input unit for receiving an input motion from the actor through a sensor attached to the body of the actor, a performance processor for creating a virtual space and reproducing a performance in real time according to a pre-stored scenario, a playable character (PC) played by the actor and acting based on the input motion, a non-playable character (NPC) acting independently without being controlled by the actor, an object, and a background being arranged and interacting with one another in the virtual space, and an output unit for generating a performance image from the performance reproduced by the performance processor and outputting the performance image to a display device. The scenario includes a plurality of scenes having at least one branch and the scenes are changed or extended by accumulating composition information thereof according to the performance of the actor or an external input.

The performance processor may guide the actor to perform a scene by providing a script of the scenario suitable for the scene to the actor in real time with the passage of time and may determine a next scene of the scenario by identifying the branch based on the performance of the actor according to the selected script.

The performance processor may change or extend the scenario by collecting a speech improvised by the actor during the performance and registering the collected speech to a database storing the script.

To achieve the above object, one embodiment of the present invention provides a method for processing a virtual video performance using a performance of an actor, the method including receiving an input motion from the actor through a sensor attached to the body of the actor, creating a virtual space in which a playable character (PC) played by the actor and acting based on the input motion, a non-playable character (NPC) acting independently without being controlled by the actor, an object, and a background are arranged and interact with one another, reproducing a performance in real time in the virtual space according to a pre-stored scenario, and generating a performance image from the performance reproduced by the performance processor and outputting the performance image to a display device.

The creation of a virtual space may include determining an action of the NPC based on input information of the PC and environment information about the object or the virtual space, and dynamically changing the action of the NPC in the virtual space according to an input motion from the actor or an interaction between the PC and the NPC.

The reproduction of a performance in real time may include providing the actor in real time with information about an interaction and relationship between the PC and the NPC or the object according to the performance of the actor, and synchronizing the PC, the NPC, and the object in the virtual space by visually providing the interaction and relationship information to the actor through the display device or in the form of at least one of shock or vibration through a tactile means attached to the body of the actor.

A computer-readable recording medium recording a program to implement the method for processing a virtual video performance in a computer is also provided.

### Advantageous Effects

According to the embodiments of the present invention, three-dimensional (3D) information is extracted from actors, images are generated based on the extracted 3D information, and a stage performance is improvised for an audience using the images. Therefore, the audience tired of two-dimensional (2D) images may enjoy a new visual fun and experience a new visual medium that enables an interaction between actors and digital content in a virtual space, with the reproducibility of a stage performance varying at each time.

### BRIEF DESCRIPTION OF THE DRAWINGS

FIG. 1 is a block diagram of an apparatus for processing a virtual video performance based on a performance of an actor according to one embodiment of the present invention;

FIG. 2 shows an exemplary technical means attached to the body of an actor to receive information about a motion or facial expression of the actor;

FIG. 3 shows an exemplary virtual space created by an operation for processing a video performance adopted in embodiments of the present invention;

FIG. 4 is a block diagram for explaining a data processing structure between a motion input unit and a performance processor in the video performance processing apparatus of FIG. 1 according to one embodiment of the present invention;

FIG. 5 illustrates an operation for controlling a non-playable character adaptively in the video performance processing apparatus of FIG. 1 according to one embodiment of the present invention;

FIG. 6 is a flowchart illustrating an operation for displaying a performance image generated by the video performance processing apparatus of FIG. 1 according to one embodiment of the present invention;

FIG. 7 is a flowchart illustrating a method for processing a virtual video performance based on a performance of an actor according to one embodiment of the present invention; and

FIG. 8 is a flowchart illustrating an operation in which an actor plays a character using the video performance processing apparatus according to embodiments of the present invention.

### EXPLANATION OF REFERENCE NUMERALS

100: Virtual video performance processing apparatus
10: Motion input unit 20: Performance processor
30: Output unit
40: Non-playable character processor 50: Synchronizer
150: Display device
310: Playable character 320: Non-playable character
330: Object 340: Background

### BEST MODE FOR CARRYING OUT THE INVENTION

According to one embodiment of the present invention, an apparatus for processing a virtual video performance using a performance of an actor includes a motion input unit for receiving an input motion from the actor through a sensor attached to the body of the actor, a performance processor for creating a virtual space and reproducing a performance in real time according to a pre-stored scenario, a playable character (PC) played by the actor and acting based on the input motion, a non-playable character (NPC) acting independently without being controlled by the actor, an object, and a background being arranged and interacting with one another in the virtual space, and an output unit for generating a performance image from the performance reproduced by the performance processor and outputting the performance image to a display device.

### MODE FOR CARRYING OUT THE INVENTION

Before describing embodiments of the present invention, technical elements required for an environment where the embodiments of the present invention are implemented and used will be investigated and the basic idea and configuration of the present invention will be presented based on the technical elements.

In response to consumers' various needs in films, performance art, and games in varying environments, as stated earlier, embodiments of the present invention provide a new type of media infrastructure in which a live video performance can be performed on a screen stage according to an interactive narrative using digital marionette and role-playing game (RPG) techniques through motion capture of three-dimensional (3D) computer graphics.

Particularly, embodiments of the present invention derive a new genre of media system by combining various features of conventional media. That is, according to embodiments of the present invention, a new medium is provided that offers exquisite images such as photorealistic images through a digital marionette by 3D computer graphics and has different reproducibility of a theatrical play or a musical at each time in the limited time and space of a stage, high-performance computer-aided interaction, and the features of a role-playing game.

Traditional Czech marionettes are puppets whose limbs and heads are controllably moved from above by strings connected thereto to play characters vividly. In the embodiments of the present invention, an actor manipulates a digital marionette using special equipment for 3D computer graphics (motion capture or emotion capture) to play a character. Accordingly, as in a traditional marionette performance, one actor may be allocated per digital character in the new performance medium proposed in the embodiments of the present invention.

A gamer plays the role of a specific character using a computer input device such as a keyboard, a mouse, a joystick or a motion sensing remote control in a conventional role-playing video game. Similarly to this, each actor plays a specific digital marionette character through motion and emotion capture in the embodiments of the present invention as if the actor manipulated the digital marionette character. The new performance medium proposed in the embodiments of the present invention has both the feature of a story developed according to a preset guideline or rule and the feature of an interactive game. Eventually, a digital marionette performs a little bit differently at each performance depending on an actor, as in a traditional theatrical play.

A small-scale orchestra plays live music in a semi-underground space in front of a stage to offer a vivid sound effect at one with a stage performance in most musicals or plays running on Broadway in New York or in the East End of London. Similarly to the foregoing musicals or plays, actors play digital marionettes in a semi-underground space or in some limited zones above a stage (for example, spaces showing the existence of actors or actresses to an audience are available) in the embodiments of the present invention. The stage is basically displayed on a screen with a sense of reality based on exquisite computer graphics almost like a 3D film.

For this purpose, the new media performance proposed by the embodiments of the present invention is performed on a stage in real time by merging an almost realistic 3D computer graphical screen with the performance of an actor manipulating a digital marionette. Accordingly, scenes that are difficult to represent in a conventional stage performance, for example, a dangerous scene, a fantastic scene and a sensual scene, are created by computer graphics and real-life shooting, and a whole image output obtained by interworking the images with an interactive system such as a game is displayed to an audience. An actor wearing special equipment recognizes an image and a virtual space on a screen and performs while being aware of other actors and a background and interacting with them. As a consequence, a new style of video performance having different reproducibility at each time is created as in a traditional stage performance characterized by different representations or impressions depending on the performance of actors, unlike a film that is repeated without any change at each time.

Now, a description will be given of technical means to achieve the object introduced above, that is, a new media infrastructure system for a video stage performance.

A video stage performance system refers to a system in which a number of marionette actors are connected to and interact with one another in real time. These users may be scattered in different places. In general, an actor receives a user interface (UI) for the video stage performance system through a digital marionette control device. This environment serves as a virtual stage sufficient for marionette actors to concentrate on their performance. Thus, the environment should be able to offer a sense of reality by merging 3D computer graphics with stereo sounds.

For this purpose, the video stage performance system preferably has the following five features.

A) Sharing of spatial perception: All marionette actors should have a common illusion that they are on the same stage. Although the space may be real or virtual, the shared space should be represented with a common feature to all marionette actors. For example, all actors should be able to perceive the same temperature or weather as well as the same auditory sense.

B) Sharing of existence perception: Marionette actors are allocated to respective characters in a video stage performance, such as roles in a play. The characters may be masks called persona. Such marionette characters are represented as 3D graphic images and have features such as body models (e.g., arms, legs, feelers, tentacles, and joints), motion models (e.g., a motion range in which joints are movable), and appearance models (e.g., height and weight). The marionette characters do not necessarily take a human form. For example, the marionette characters may be shaped into animals, plants, machines or aliens. Basically, when a new actor enters the video stage environment, the actor may view other marionette characters on a video stage with the eyes or on a screen of his marionette control device. Other marionette actors may also view the marionette character of the new marionette actor. Likewise, when a marionette actor leaves the video stage environment, other marionette actors may also see the marionette character of the actor leave.

However, all marionette characters do not need to be manipulated by actors. That is, a marionette character may be a virtual existence manipulated by an event-driven simulation model or a rule-based inference engine in the video stage environment. Hereinafter, this marionette character is referred to as a non-playable character (NPC) and a marionette character manipulated by a specific actor is referred to as a playable character (PC).

C) Sharing of time perception: Each marionette actor should be able to recognize actions of other actors at the moment the actions are taken and to respond to the actions. That is, the video stage environment should support an interaction regarding an event in real time.

D) Communication method: An efficient video stage environment provides various means through which actors may communicate with one another, such as motions, gestures, expressions, and voices. These communication means provide an appropriate sense of reality to the virtual video stage environment.

E) Sharing method: The true power of the video stage environment lies not in the virtual environment itself but in the action capabilities of actors who are allowed to interact with one another. For example, marionette actors may attack or collide with each other in a battle scene. A marionette actor may pick up, move or manipulate something in the video stage environment. A marionette actor may pass something to another marionette actor in the video stage environment. Accordingly, a designer of the video stage environment should support to allow the actors to freely manipulate the environment. For example, a user should be able to manipulate the virtual environment through actions such as planting a tree in the ground, drawing a picture on a wall, or even destroying an object or a counterpart actor in the video stage environment.

In summary, the video stage performance system proposed by the embodiments of the present invention provides plenty of information to marionette actors, allows the marionette actors to share and interact with one another, and supports to allow the marionette actors to manipulate objects in a video stage environment. In addition, the existence of a number of independent players is an important factor that differentiates the video stage performance system from a virtual reality or a game system.

Eventually, the video stage performance system proposed by the embodiments of the present invention needs a technique for immediately showing an actor's motion as a performance scene through motion or emotion capture. That is, real-time combination of a captured actor's motion with a background by a camera technology using a high-performance computer with a fast computation capability may help actors or a director to be immersed deeper into the performance. In this case, performances and speeches of actors should be synchronized with sound effects in the development of a story. In addition to the delivery of live music and sound, a sound processing means such as a small-scale orchestra in a conventional musical may still be effective for the synchronization.

Exemplary embodiments of the present invention will now be described in more detail with reference to the attached drawings. In the description and drawings of the present invention, detailed explanations of well-known functions or constructions are omitted since they may unnecessarily obscure the subject matter of the present invention. It should be noted that wherever possible, the same reference numerals denote the same parts throughout the drawings.

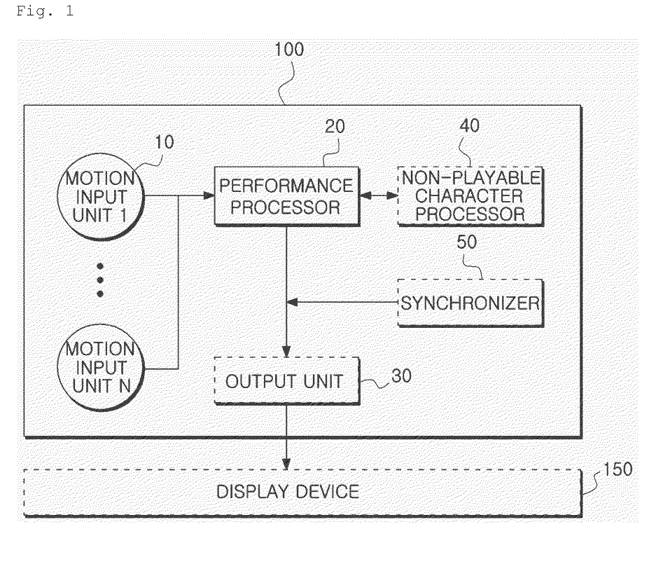

FIG. 1 is a block diagram of an apparatus for processing a virtual video performance based on a performance of an actor according to one embodiment of the present invention. The apparatus may include at least one motion input unit 10, a performance processor 20, and an output unit 30. The apparatus may optionally include a non-playable character (NPC) processor 40 and a synchronizer 50.

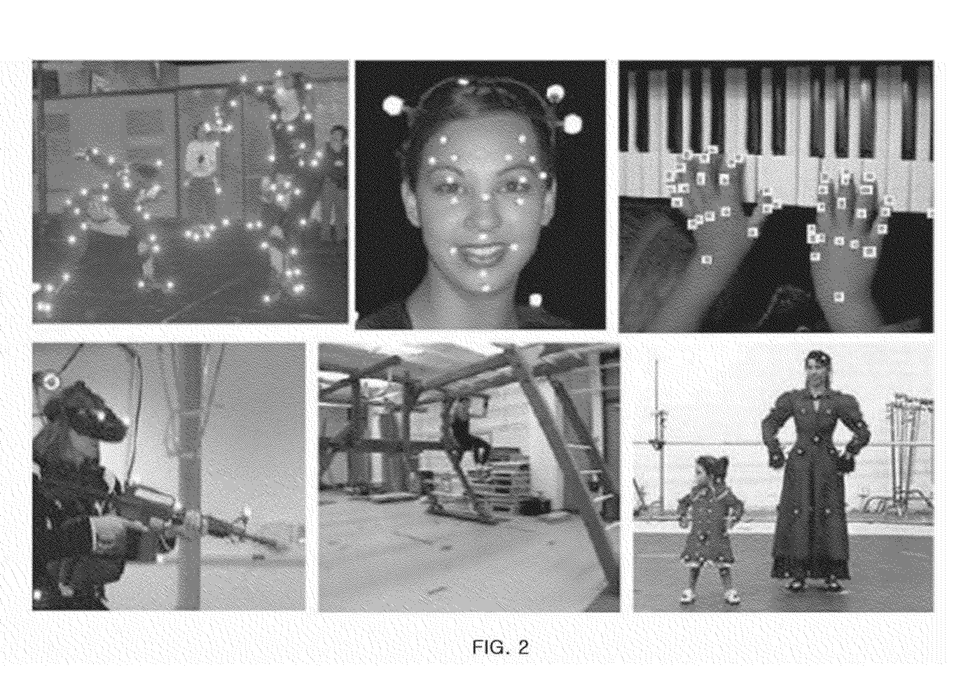

The motion input unit 10 receives a motion through sensors attached to the body of the actor. Preferably, the motion input unit 10 includes at least one of a sensor attached to a body part of the actor to sense a motion of the body part and a sensor marked on the face of the actor to sense a change in a facial expression of the actor. Particularly, the motion input unit 10 senses 3D information about a motion or a facial expression of the actor and the performance processor 20 creates a 3D digital character (corresponding to the digital marionette explained earlier) controlled in response to the motion or facial expression of the actor based on the sensed 3D information. The motion input unit 10 may be implemented as a wearable marionette control device, and a more detailed description thereof will be described with reference to FIG. 2.

The performance processor 20 creates a virtual space in which a playable character (PC) played by the actor and acting based on the input motion of the actor, a non-playable character (NPC) independently acting without being controlled by the actor, an object, and a background are arranged and interact with one another, and reproduces a performance in real time according to a pre-stored scenario. According to this embodiment of the present invention, all of the four components, i.e. the PC, the NPC, the object, and the background, may be arranged in a generated image. Specifically, the PC may be a digital marionette controlled by the actor, the NPC may be controlled by computer software, and the object may reside in a virtual space. These components may be arranged selectively in a single virtual space depending on a scene. The performance processor 20 may be implemented as a physical performance processing system or server that can process image data.

The output unit 30 generates a performance image from the performance reproduced by the performance processor 20 and outputs the performance image to a display device 150. When needed, the output unit 30 may also be electrically connected to a sound providing means such as an orchestra to generate a performance image in which an image and a sound are combined. The output unit 30 may be implemented as a graphic display device for outputting a stage performance image on a screen.

The central performance processor may be exclusively responsible for all image processing to effectively represent a digital marionette. In some cases, however, marionette control devices (motion input means) attached to the bodies of actors may be configured to independently perform communication and individual processing. That is, the marionette control device worn by each actor performs motion capture and emotion capture to accurately capture a motion, an emotion, and a facial expression of the actor in real time, and provides corresponding data to the performance processor 20. A marionette actor may use equipment such as a head mounted display (HMD) for emotion capture but may also share a screen stage image that dynamically changes according to his performance through a small, high-resolution display device mounted on his body part (for example, on his breast), for convenience of performance. This structure offers a virtual stage environment where the marionette actor feels as if he performs on an actual stage.

Marionette actors are required to exchange various types of information with the video stage performance system. Thus, it is preferred that the marionette actors are always in contact with the performance processing server through a network. For example, if an actor playing a specific marionette character moves, information about the actor's movement should be indicated to other marionette actors through the network. The marionette characters may be visually located at more accurate positions on a screen through the updated information. Further, in the case where a marionette character picks up a certain object and moves with the object on a video stage screen, other marionette actors need to recognize the scene and receive information about the movement of the object through marionette control devices. Besides, the network plays an important role in synchronizing states (such as weather, fog, time, and topography) to be shared on the video stage performance.

In the embodiment illustrated in FIG. 1, the motion input unit 10 may be provided as many as the number of actors. In this case, the motion input units 10 may be electrically connected to separate sensing spaces and receive motions from sensors attached to the bodies of the actors in the respective sensing spaces. In this case, the performance processor 20 arranges a plurality of PCs played by the actors in the respective sensing spaces, the NPC, the object, and the background in one virtual space to generate a joint performance image of the actors.

It is typical that a marionette actor accesses a single performance processing server in the same space through a control device to participate in a whole performance, but some marionette actors may participate in the video stage performance through a remote network although they are not in the same place. However, if actions and performances of the actors are not reflected in the screen through their marionette control devices, a sense of reality and the degree of audience immersion are reduced. This means that the performance of a digital marionette actor should be processed immediately in the video stage performance system and fast data transmission and reception as well as fast processing is thus required. Accordingly, in the case where a marionette actor is not co-located with the performance processing server in the same space, it is preferred that the remote network services mostly via transmission control protocol (TCP) or user datagram protocol (UDP), for fast signal processing. On the whole, traffic increases at the moment of system login requiring transmission of much data at the start of a performance and at the event of screen movement, for example, due to scene switching. A data transmission and reception rate for synchronization of the contents of a performance is significantly affected by the number of marionette actors who play simultaneously and scenario scenes. In the case of an action scene requiring much traffic, the TCP increases a transmission delay with increasing number of connected actors or increasing amount of transmission data, thus being unsuitable for a real-time action. Therefore, in some cases, it would be desirable to utilize a high-speed communication protocol such as UDP.

FIG. 2 shows an exemplary technical means attached to the body of an actor to receive a motion or a facial expression of the actor. As shown in FIG. 2, various sensors are attached to the body or face of the actor so that motions of the actor can be sensed or changes in the facial expression of the actor may be extracted through markings.

A close look at motions of computer graphic characters on TV or in a game reveals that the characters move their limbs or other body parts as naturally as humans. The naturalness of motions is possible because sensors are attached to various body parts of an actor and provide sensed motions of the actor to a computer where the motions are reproduced graphically. This is a motion capture technology. The sensors are generally attached on body parts, such as head, hands, feet, elbows and knees, where large motions occur.

In embodiments of the present invention, it is preferred to immediately monitor an actual on-scene motion of an actor as a film scene. According to the prior art, an actual combined screen can be viewed only after a captured motion is combined with a background by an additional process. In contrast, the use of the video performance processing apparatus proposed in the embodiments of the present invention enables the capture of a motion and simultaneously real-time monitoring of a virtual image in which the captured motion is combined with other objects and backgrounds. For this purpose, a virtual camera technology is preferably adopted in the embodiments of the present invention.

A general film using computer graphics uses the ‘motion capture’ technology to represent a motion of a character with a sense of reality. Further, the embodiments of the present invention may use ‘emotion capture’. The emotion capture is a capture technology that is elaborate enough to capture facial expressions or emotions of actors as well as motions of the actors. That is, even facial expressions of an actor are captured by means of a large number of sensors and are thus represented as life-like as possible by computer graphics. For this purpose, a subminiature camera is attached in front of the face of the actor. The use of the camera enables the capture of very fine movements including twitching of eyebrows as well as muscular motions of the face according to facial expressions and the graphic reproduction of the captured movements.

The sensor-based emotion capture method advantageously constructs a database from facial expressions sensed by sensors attached on the face of an actor. However, the sensor attachment renders the facial performance of the actor unnatural and makes it difficult for his on-stage counterpart to bring empathy to his role. Accordingly, main muscular parts of the face of an actor may be marked in specific colors and the facial performance of the actor may be captured through a camera capable of recognizing the markers in front of the actor's face, rather than sensors are attached on the face of the actor. That is, facial muscles, eye movements, sweat pores, and even eyelash tremors may be recorded with precision by capturing the face of the actor at 360 degrees using the camera. Once the facial data and facial expressions are recorded using the camera, a digital marionette may be created based on the facial data values and reference expressions.

According to embodiments of the present invention, the video stage performance processing apparatus may further include a communication unit having at least two separate channels. One channel of the communication unit may be inserted in a performance by receiving a speech from the actor, and the other channel may be used for communication between the actor and any other actor or person without being exposed in the performance. That is, the two channels have different functions.

A marionette control device may perform operations exemplified in Table 1.

TABLE 1

| Step | Procedure and contents |
|---|---|
| Step | The marionette control device essentially includes a camera for |
| 1 | facial expression and emotion capture, various sensors (an |
| | acceleration sensor, a directional and gravitational sensor, |
| | etc.) for motion capture, and a wireless network such as wireless |
| | fidelity (Wi-Fi) or Bluetooth for reliable communication. |
| Step | A marionette actor is connected in real time to the performance |
| 2 | processing server through the wireless network using the |
| | marionette control device. A virtual stage environment is |
| | provided to the marionette actor through the marionette control |
| | device so that the marionette actor may feel as if he performs on |
| | a real stage. |
| Step | When the marionette actor performs a specific scene, the |
| 3 | marionette control device reads video stage environment |
| | information from the performance processing system through the |
| | wireless network such as Bluetooth or Wi-Fi and sets up a video |
| | stage environment based on the information. Along with switching |
| | to a specific scene, each marionette actor receives a specific |
| | script read from the performance processing server through the |
| | network. |
| Step | The script provides character information included in the |
| 4 | specific scene. As the performance proceeds, a virtual stage |
| | environment engine of the marionette control device synchronized |
| | with the performance processing server outputs short speeches and |
| | role commands as texts, graphical images, voices, etc. one at a |
| | time through a UI. |
| Step | To play a given character in the scenario, the marionette actor |
| 5 | perceives a specific performance progress using information about |
| | a specific object or background in the virtual stage environment |
| | generated by the marionette control device and provided through |
| | the UI and cooperates with other actors in the performance. |
| Step | A performance director and the marionette actor can directly |
| 6 | communicate with other marionette actors without intervention of |
| | the central performance processing server. That is, the |
| | marionette actor can make difficult motions and perform during |
| | the performance by direct communication with other actors through |
| | the wireless network. |
| Step | After the marionette actor plays a role in the specific scene |
| 7 | according to the scenario, the marionette control device |
| | registers the performance of the actor to the performance |
| | processing server through the network. |

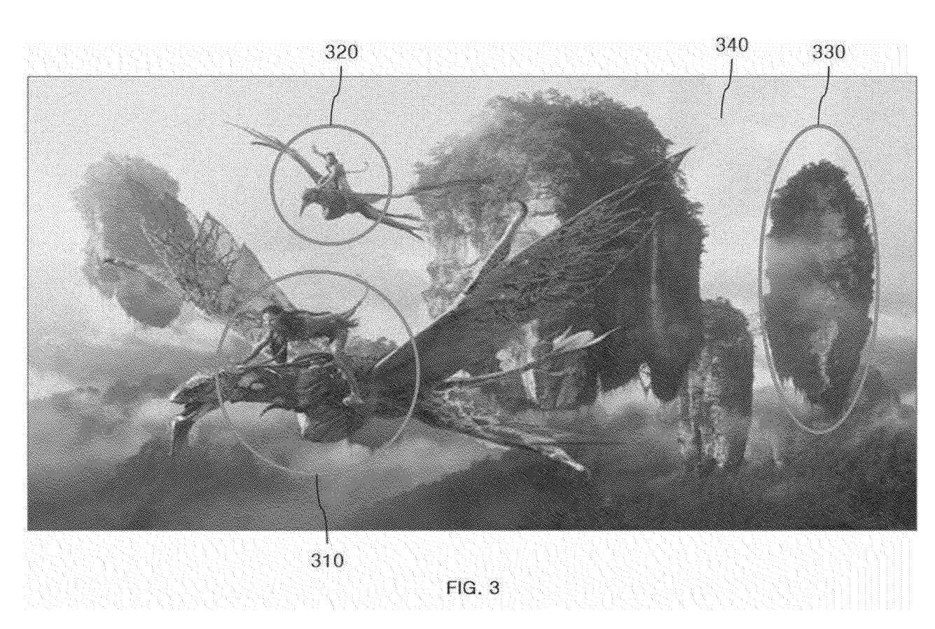

FIG. 3 shows an exemplary virtual space created by the visual performance processing operation adopted in the embodiments of the present invention. As introduced earlier, a playable character (PC) 310 controlled by an actor, a non-playable character (NPC) 320 controlled independently by software, an object 330, and a background 340 are combined in one virtual space in FIG. 3.

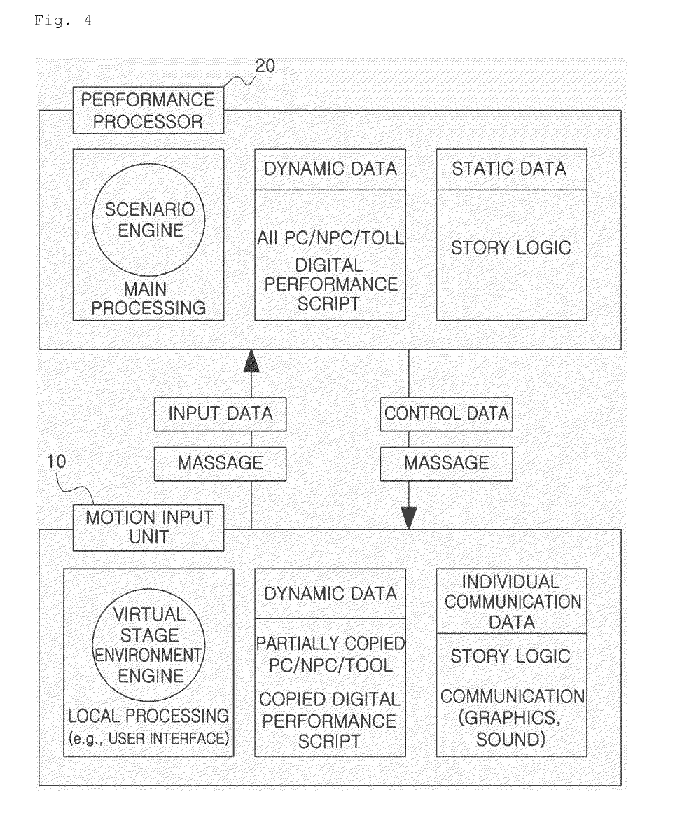

FIG. 4 is a block diagram for explaining a data processing structure between the motion input unit and the performance processor in the video performance processing apparatus of FIG. 1 according to one embodiment of the present invention.

The performance processor 20 provides an actor with a scenario script suitable for a scene in real time with the passage of time to guide an actor to play the scene. The scenario script may be provided to the actor through the motion input unit 10.

As explained above, the performance processor 20 is responsible for the progress of a substantial performance in the video stage performance system. The performance processor 20 has all ideas of the director and all techniques required for narrative development, such as scene descriptions and plots used for film production. The performance processor 20 performs an operation to comprehensively control all elements necessary for the performance, thus being responsible for the majority of tasks. Due to a vast number of elements involved in the performance, there is a risk that processing of all tasks in the single performance processor 20 may lead to system overload.

Performance data management and processing between the performance processor 20 and the motion input unit 10, that is, the marionette control device, is illustrated in FIG. 4. A basic role of the performance processor 20 is to manage a virtual stage. The performance processor 20 manages a stage screen and an NPC and processes an input from the motion input unit 10. The performance processor 20 periodically generates information about the virtual stage as performance data snapshots and transmits the performance data snapshots to the motion input unit 10. The motion input unit 10 responsible for interfacing transmits an input received from a marionette actor to the performance processor 20, maintains local data about the virtual stage, and outputs the local data on a marionette screen.

In FIG. 4, dynamic data refers to data that continuously changes in the course of a performance. PC and NPC data correspond to dynamic data. An object may be a PC or an NPC or may exist separately. If the object is separate from a background, it needs management like a PC or an NPC.

Meanwhile, static data (or a logical map) refers to logical structure information about a background screen. For example, the static data describes the location of a tree or a building on a certain tile and the location of an obstacle in a certain place where movement is prohibited. Typically, this information does not change. However, if a user can build a new structure or can destroy a structure, the change of the object should be managed in the region of a dynamic data. The static data includes a graphic resource as an element that provides various effects such as a background screen, an object, and movement of a PC or NPC character.

For example, the performance processing server performs operations exemplified in Table 2.

TABLE 2

| Step | Procedure and contents |
|---|---|
| Step | The performance processing server creates a real video scene in |
| 1 | real time by combining the performance of a 3D digital |
| | marionette with a background, simultaneously with the |
| | performance of the 3D digital marionette. The performance |
| | processing server preserves a narrative for the performance, a |
| | scenario engine, a pre-produced 2D background image, a digital |
| | performance scenario, and a story logic, and flexibly controls |
| | an NPC synchronization server and a synchronization server for |
| | screen display. |
| Step | A scenario and a script for a real performance can be set and |
| 2 | changed by software. Therefore, the contents of the performance |
| | are generated from the performance server all the time according |
| | to the input scenario, and marionette actors and NPCs perform |
| | according to the scenario. |
| Step | The central performance processing server generates an |
| 3 | appropriate script based on specific positions of characters or |
| | objects in a current video screen and changes in the video |
| | screen through the scenario engine and the story logic and |
| | provides the script to each marionette actor for the next scene. |
| Step | If a marionette actor causes a change to a specific object or |
| 4 | displaces a living being (a human or an animal) on a video |
| | screen through a marionette control device in a corresponding |
| | scene, the change is reflected in the performance processing |
| | server and the scenario and script of the next scene is thus |
| | affected. |

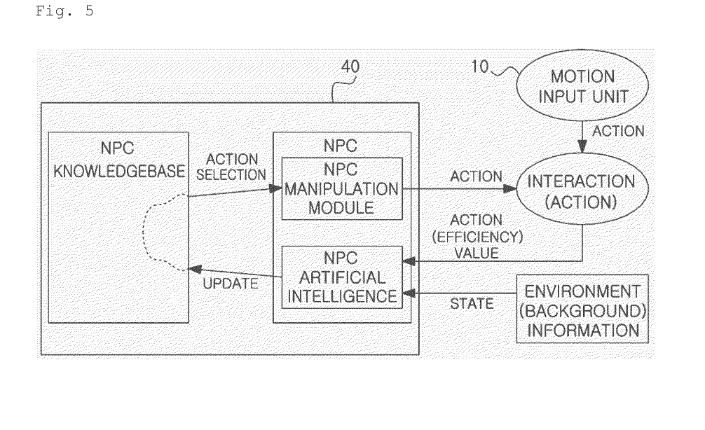

FIG. 5 illustrates an operation for controlling an NPC adaptively in the video performance processing apparatus of FIG. 1 according to one embodiment of the present invention. The video performance processing apparatus further includes an NPC processor 40. The NPC processor 40 determines an action of an NPC based on input information from a PC and environment information about an object or a virtual space. That is, the NPC processor 40 dynamically changes the action of the NPC in the virtual space based on a motion input from an actor or an interaction between a PC and the NPC. Further, referring to a knowledgebase of actions of the NPC, the NPC processor 40 adaptively selects an action of the NPC based on the input information or the environment information. At this time, it is preferred to determine such that the selected action of the NPC matches the scenario.

The NPC, which is controlled by the performance processing server rather than by an actor, plays a relatively limited and simple role. The NPC plays mainly a minor role or a crowd member. The artificial intelligence of the NPC may cause much load on the progress of a performance depending on a plot. In general, the role of the NPC looks very simple in a film based on computer graphics. However, construction of artificial intelligence for a number of NPCs is very complex and requires a huge amount of computation. Accordingly, separate processing of an artificial intelligence part of an NPC may contribute to a reduction in the load of the performance processor, as illustrated in FIG. 5.

According to embodiments of the present invention, the virtual video performance processing apparatus may further include the synchronizer 50, as illustrated in FIG. 1. The synchronizer 50 performs a role in synchronizing a PC, an NPC, and an object with one another in a virtual space by providing information about an interaction and relationship between the PC and the NPC or the object in real time according to the performance of an actor. The interaction and relationship information includes the magnitude of a force calculated from a logical position relationship between the PC and the NPC or the object in the virtual space. The interaction and relationship information may be provided to the actor largely through two means: one is to visually provide the interaction and relationship information to the actor through the display device 150 illustrated in FIG. 1; and the other is to provide the interaction and relationship information to the actor in the form of at least one of shock or vibration through a tactile means attached to the body of the actor.

The video stage performance system may be regarded as a kind of community and it may be said that a performance is performed by an interaction between digital marionette actors. Communication is essential in a community and characters communicate with each other by their speeches on the whole. That is, according to embodiments of the present invention, the video performance processing apparatus 100 should recognize speeches of digital actors and appropriately respond to the speeches for synchronization.

Therefore, a synchronization means is needed for synchronization among actors including an NPC, in addition to the performance processor 20 and the NPC processor 40. The most basic operation of the video performance processing apparatus 100 is synchronization among characters. The synchronization is performed the moment performance processing starts and marionette characters including an NPC start to perform. The synchronization is to let an actor recognize actions of other actors in a limited space. For mutual recognition of actors' actions, an action of each character should be known to other nearby characters. This is a cause of much load. Therefore, the performance of performance processing may be improved when a device dedicated to synchronization is separately configured. Since synchronization between a digital marionette actor and an NPC is performed on an object basis, the separate synchronizer 50 capable of fast data processing may be dedicated to synchronization among characters to distribute load.

The NPC processor 40 and the synchronizer 50 perform operations exemplified in Table 3.

TABLE 3

| Step | Procedure and contents |
|---|---|
| Step | The performance of a digital marionette involves at least one |
| 1 | participant. Tens or hundreds of characters may appear in the |
| | performance depending on scenes. Herein, in most cases, an |
| | NPC controlled by an event-driven simulation model or a rule- |
| | based inference engine is automatically created by artificial |
| | intelligence and performs. |
| Step | Generally, a marionette actor may directly monitor |
| 2 | marionettes of other actors as well as his digital marionette |
| | displayed in real time with his eyes in an open space |
| | prepared in a part of the stage. |
| Step | If a marionette of a counterpart actor approaches a |
| 3 | predetermined distance from the marionette of the actor and |
| | applies a physical force to the marionette according to an |
| | action of the counterpart actor, an interaction is reflected |
| | in real time in the form of vibration to the marionette |
| | control device of the actor. In this manner, synchronization |
| | is achieved so that the actor may perform naturally. |

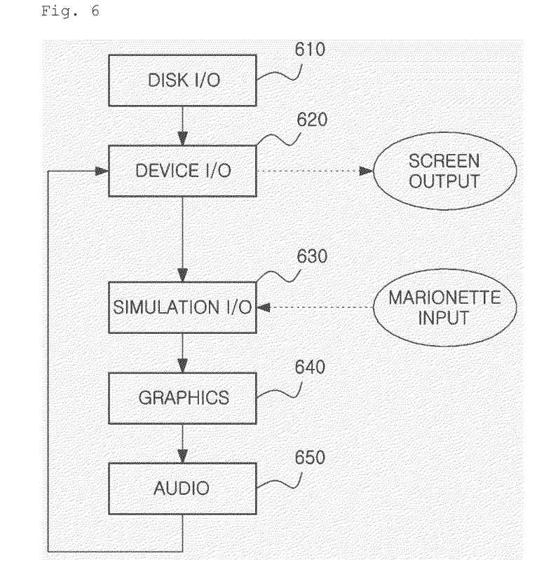

FIG. 6 is a flowchart illustrating an operation for displaying a performance image generated from the video performance processing apparatus of FIG. 1 according to one embodiment of the present disclosure. Referring to FIG. 6, in step 610, data is read from a physical disk of the performance processor and a virtual performance is reproduced. In step 620, a virtual performance image is output to the display device through a video signal input/output means of the output unit. At the start of the performance, a default performance image may be output. In step 630, digital marionette control information is received from sensors attached to the body of an actor through the motion input unit and a simulation is performed based on the control information. In step 640, an image process is performed based on the input motion information to create a combined virtual space. The voice of the actor or other background sounds are inserted in step 650. Then, the procedure returns to step 620 to output a stage performance on a screen.

The graphic display performs operations exemplified in Table 4.

TABLE 4

| Step | Procedure and contents |
|---|---|
| Step | A marionette actor transmits data of his motion and emotion |
| 1 | measured by his wearable control device to the central |
| | performance server in real time through the wireless |
| | communication network. |
| Step | The performance processing server transmits the data to the |
| 2 | graphic display server to process such collected data. |
| Step | A motion and a facial expression of each marionette actor are |
| 3 | processed and displayed in real time on the display device. |

A technical means for adaptively accumulating and changing a stage performance using the virtual video performance processing apparatus based on the performance of the actor will be proposed hereinafter. Main components (a motion input unit, a performance processor, and an output unit) of the technical means function similarly to the foregoing components, and only the differences will be described herein.

As described above with reference to FIG. 1, the performance processing unit 20 creates a virtual space in which a PC played by an actor and acting based on a motion of the actor, an NPC acting independently without being controlled by an actor, an object, and a background are arranged and interact with one another, and reproduces a performance in real time according to a scenario. In this embodiment of the present invention, the scenario includes a plurality of scenes having at least one branch and the scenes may be changed or extended by accumulating composition information thereof according to the performance of the actor or an external input.

More specifically, the performance processor provides an actor with at least one script suitable for a scene in real time with the passage of time to guide the actor to perform the scene of the scenario and identifies the branch based on the performance of the actor according to the selected script to determine the next scene of the scenario. In addition, the performance processor may change or extend the scenario by collecting speeches of an improvised performance of the actor and registering the speeches to a database that stores the script.

Further, the embodiment of the present invention may further include an NPC processor for determining an action of the NPC based on input information from the PC and environment information about the object or the virtual space. The NPC processor may identify the branch in consideration of an input motion from the actor or an interaction between the PC and the NPC to dynamically change the action of the NPC so as to be suitable for the identified branch.

That is, since some scenes, situations, or speeches of the scenario may be changed gradually during a repeated performance in the embodiment of the present invention, different reproducibility can be provided to an audience each time, like a theatrical performance.

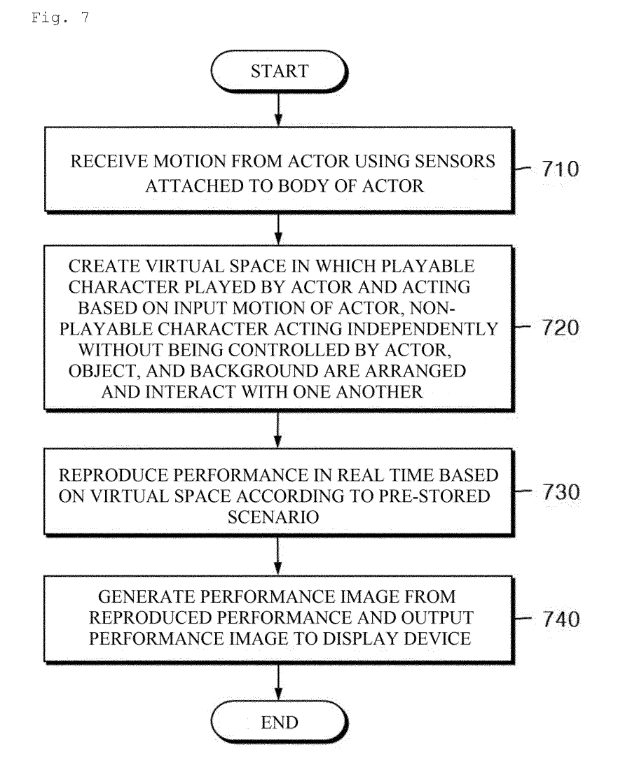

FIG. 7 is a flowchart illustrating a method for processing a virtual video performance based on a performance of an actor according to one embodiment of the present invention. The operations of the performance processing apparatus and its components illustrated in FIG. 1 have been described and thus only the procedure will be briefly described on the basis of time.

In step 710, a motion of an actor is received from sensors attached to the body of the actor.

In step 720, a virtual space is created in which a PC played by the actor and thus acting based on the motion input in step 710, an NPC acting independently without being controlled by an actor, an object, and a background are arranged and interact with one another. Specifically, this operation may be performed by determining an action of the NPC based on the input information about the PC and environment information about the object or the virtual space, and dynamically changing the action of the NPC in the virtual space according to the motion input from the actor or interaction between the PC and the NPC.

In step 730, a performance is reproduced based on the created virtual space according to a pre-stored scenario. Specifically, information about the interaction and relationship between the PC and the NPC or the object according to the performance of the actor is provided in real time to the actor; and the interaction and relationship information is provided to the actor visually or in the form of at least one of shock or vibration through a tactile means attached to the body of the actor to synchronize the PC, the NPC, and the object in the virtual space.

In step 740, a performance image is created from the performance reproduced in step 730 and is then output on the display device.

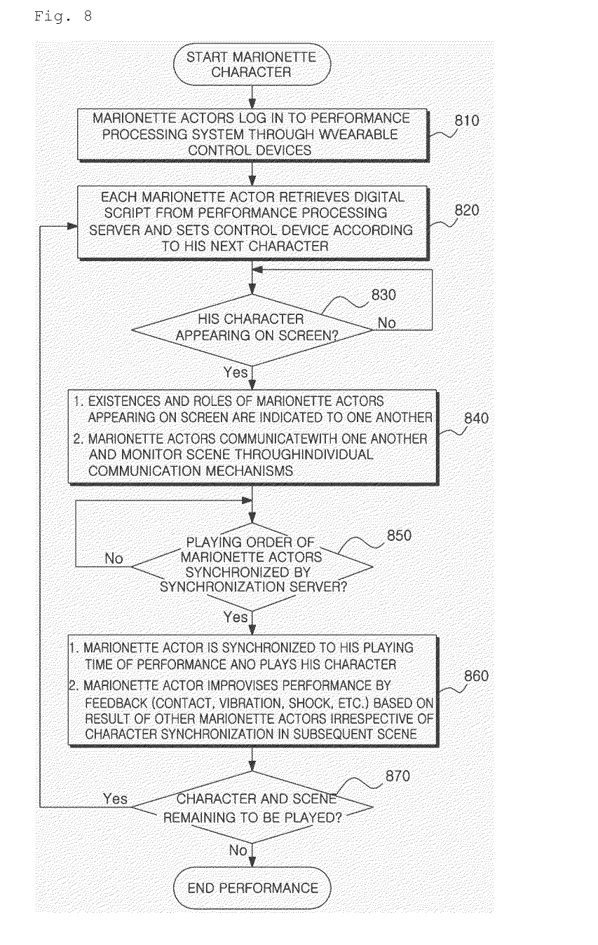

FIG. 8 is a flowchart illustrating an operation in which an actor plays a character using the video performance processing apparatus according to embodiments of the present invention.

In step 810, marionette actors log in to the performance processing system through their wearable control devices that can be attached to the bodies of the users. In step 820, each marionette actor retrieves a digital script from the performance processing server and sets the marionette control device according to his next character suitable for the next scene. In step 830, the marionette actor determines whether his character appears on a screen. When it is time to perform, the marionette actor proceeds to step 840. That is, the existences and roles of marionette actors appearing on the screen are indicated to one another, and each marionette actor monitors a scene by communicating with other marionette actors through an individual communication mechanism. If the synchronization server confirms synchronization of the playing order of the marionette actor in step 850, the marionette actor proceeds to step 860 where he performs. That is, the marionette actor is synchronized to his playing time of the performance and plays his character. In addition, the marionette actor may improvise his performance, taking into account a feedback for the performance of another marionette actor irrespective of character synchronization in a subsequent scene. The feedback refers to delivery of a stimulus such as contact, vibration, or shock through a tactile means attached to the body of a user. Finally, in step 870, the marionette actor determines whether there remains a character or scene to be played by the marionette actor. If a character or scene to be played remains, the marionette actor returns back to step 820 and repeats the above operation.

The embodiments of the present invention may be implemented as computer-readable code in a computer-readable recording medium. The computer-readable recording medium may include any kind of recording device storing computer-readable data.

Examples of suitable computer-readable recording media include ROMs, RAMs, CD-ROMs, magnetic tapes, floppy disks, and optical data storage devices. Other examples include media that are implemented in the form of carrier waves (for example, transmission over the Internet). In addition, the computer-readable recording medium may be distributed over computer systems connected over the network, and computer-readable codes may be stored and executed in a distributed manner. Functional programs, codes, and code segments for implementing the present invention may be readily derived by programmers in the art.

The present invention has been described with reference to certain exemplary embodiments thereof. It will be understood by those skilled in the art that the invention can be implemented in other specific forms without departing from the essential features thereof. Therefore, the embodiments are to be considered illustrative in all aspects and are not to be considered as limiting the invention. The scope of the invention is indicated by the appended claims rather than by the foregoing description. All changes which come within the meaning and range of equivalency of the claims should be construed as falling within the scope of the invention.

### INDUSTRIAL APPLICABILITY

The new performance infrastructure according to the embodiments of the present invention is not a simple motion and emotion capture system and can reflect all motions and emotions of an actor in a 3D digital character in real time. That is, the actor can provide a sense of reality to the situation of a performance screen through a wearable digital marionette control device that enables immersion of the actor in the performance. In addition, an on-stage performance can be provided to an audience by integrating the real-time performance of the digital marionette with a pre-captured and pre-produced video screen, and a plurality of actors in different spaces can participate in the performance through their digital marionette control devices connected to a network. As a result, a famous actor does not need to travel to countries or cities for performance. A method for communication between actors or between an actor and a director behind the scene can be provided during digital marionette performance, in addition to a scenario-based communication method of the performance processing server. Further, the embodiments of the present invention can use a method for sharing state information in real time through a network as well as a method for interacting between actors while the actors view a screen with their eyes, in a situation in which a change in the motion of digital marionettes and the movement of an object (a tool) on a video screen should be shared.

Important requirements of actors are internal talents such as dance, singing, and performance rather than physical features of the actors playing digital marionettes such as height, face, and figure. The use of the system proposed by the embodiments of the present invention makes the performances of actors more important than the outward appearances of the actors and enables the appearance of past or current famous actors as life-like digital marionettes in a performance even though they do not perform directly. In other words, since actual actors speak and sing in real time as digital marionette characters, internally talented actors of a new style can perform on stage and the choice of actors can thus be widened. Furthermore, a plurality of actors can play one role because performance is different per role and an audience views the performance of one digital marionette.

1. An apparatus for processing a virtual video performance using a performance of an actor, the apparatus comprising:
a motion input unit for receiving an input motion from the actor through a sensor attached to the body of the actor;
a performance processor for creating a virtual space and reproducing a performance in real time according to a pre-stored scenario, a playable character (PC) played by the actor and acting based on the input motion, a non-playable character (NPC) acting independently without being controlled by the actor, an object, and a background being arranged and interacting with one another in the virtual space; and
an output unit for generating a performance image from the performance reproduced by the performance processor and outputting the performance image to a display device.

2. The apparatus according to claim 1, wherein the motion input unit comprises at least one of a sensor attached to a body part of the actor to sense a motion of the body part and a sensor marked on the face of the actor to sense a change in a facial expression of the actor.

3. The apparatus according to claim 2, wherein the motion input unit senses three-dimensional (3D) information about a motion or a facial expression of the actor, and the performance processor generates a 3D digital character controlled in response to the motion or facial expression of the actor based on the sensed 3D information.

4. The apparatus according to claim 1, wherein the performance processor guides the actor to perform a scene by providing a script of the scenario suitable for the scene to the actor in real time with the passage of time.

5. The apparatus according to claim 1, wherein the motion input unit is provided as many as the number of actors, the motion input units are electrically connected to separate sensing spaces and receive motions of the actors in the respective sensing spaces through sensors attached to the bodies of the actors in the respective sensing spaces, and the performance processor arranges a plurality of PCs played by the actors, the NPC, the object, and the background in one virtual space to generate a joint performance image of the actors.

6. The apparatus according to claim 1, further comprising an NPC processor for determining an action of the NPC based on input information of the PC and environment information about the object or the virtual space, wherein the NPC processor dynamically changes the action of the NPC in the virtual space according to an input motion from the actor or an interaction between the PC and the NPC.

7. The apparatus according to claim 6, wherein the NPC processor adaptively selects an action of the NPC based on the input information or the environment information referring to a knowledgebase of actions of the NPC, and the NPC processor determines that the selected action of the NPC matches the scenario.

8. The apparatus according to claim 1, further comprising a synchronizer for synchronizing the PC, the NPC and the object in the virtual space by providing the actor in real time with information about an interaction and relationship between the PC and the NPC or the object according to the performance of the actor.

9. The apparatus according to claim 8, wherein the interaction and relationship information comprises the magnitude of a force calculated from a logical position relationship between the PC and the NPC or the object in the virtual space and is visually provided to the actor through the display device.

10. The apparatus according to claim 8, wherein the interaction and relationship information comprises the magnitude of a force calculated from a logical position relationship between the PC and the NPC or the object in the virtual space and is provided to the actor in the form of at least one of shock or vibration through a tactile means attached to the body of the actor.

11. The apparatus according to claim 1, further comprising a communication unit having at least two separate channels, wherein a first channel of the communication unit receives a speech from the actor and is inserted into the performance, and a second channel of the communication unit is used for communication between the actor and another actor or person without being exposed in the performance.

12. An apparatus for processing a virtual video performance using a performance of an actor, the apparatus comprising:
a motion input unit for receiving an input motion from the actor through a sensor attached to the body of the actor;
a performance processor for creating a virtual space and reproducing a performance in real time according to a pre-stored scenario, a playable character (PC) played by the actor and acting based on the input motion, a non-playable character (NPC) acting independently without being controlled by the actor, an object, and a background being arranged and interacting with one another in the virtual space; and
an output unit for generating a performance image from the performance reproduced by the performance processor and outputting the performance image to a display device,
wherein the scenario comprises a plurality of scenes having at least one branch and the scenes are changed or extended by accumulating composition information thereof according to the performance of the actor or an external input.

13. The apparatus according to claim 12, wherein the performance processor guides the actor to perform a scene by providing a script of the scenario suitable for the scene to the actor in real time with the passage of time and determines a next scene of the scenario by identifying the branch based on the performance of the actor according to the selected script.

14. The apparatus according to claim 12, wherein the performance processor changes or extends the scenario by collecting a speech improvised by the actor during the performance and registering the collected speech to a database storing the script.

15. The apparatus according to claim 12, further comprising an NPC processor for determining an action of the NPC based on input information of the PC and environment information about the object or the virtual space,
wherein the NPC processor identifies the branch in consideration of an input motion from the actor or an interaction between the PC and the NPC to dynamically change the action of the NPC so as to be suitable for the identified branch.

16. A method for processing a virtual video performance using a performance of an actor, the method comprising:
receiving an input motion from the actor through a sensor attached to the body of the actor;
creating a virtual space in which a playable character (PC) played by the actor and acting based on the input motion, a non-playable character (NPC) acting independently without being controlled by the actor, an object, and a background are arranged and interact with one another;
reproducing a performance in real time in the virtual space according to a pre-stored scenario; and
generating a performance image from the performance reproduced by the performance processor and outputting the performance image to a display device.

17. The method according to claim 16, wherein the creation of a virtual space comprises determining an action of the NPC based on input information of the PC and environment information about the object or the virtual space, and dynamically changing the action of the NPC in the virtual space according to an input motion from the actor or an interaction between the PC and the NPC.

18. The method according to claim 16, wherein the reproduction of a performance in real time comprises providing the actor in real time with information about an interaction and relationship between the PC and the NPC or the object according to the performance of the actor, and synchronizing the PC, the NPC, and the object in the virtual space by visually providing the interaction and relationship information to the actor through the display device or in the form of at least one of shock and vibration through a tactile means attached to the body of the actor.
